(19) United States
(12) Patent Application Publication
(10) Pub. No.: US 2026/0203403 A1
(43) Pub. Date: Jul. 16, 2026

(54) STRUCTURAL ANOMALY DETECTION USING A GENERATIVE PROCESS

(71) Applicant: Research Foundation of the City University of New York, New York, NY (US)

(72) Inventors: Shoufu Luo, New York, NY (US); Sven Dietrich, New York, NY (US)

(21) Appl. No.: 19/448,837

(22) Filed: Jan. 14, 2026

Related U.S. Application Data
(60) Provisional application No. 63/745,498, filed on Jan. 15, 2025.

(51) Int. Cl. G06F 21/56

(52) U.S. Cl. CPC G06F 21/566; G06F 2221/034

(57) ABSTRACT

A method for structural anomaly detection, comprises receiving system data comprising interaction records, each interaction record including a first entity, an activity, and a second entity; applying a generative process to compute latent variables corresponding to the first entity and the second entity, wherein the latent variables represent functional roles; computing a probability matrix based on the latent variables to quantify a likelihood of each entity performing each of the functional roles; discovering structural rules by aggregating interactions between the functional roles; comparing an observed activity from an interaction record of the interaction records against the structural rules to compute a probability of the observed activity; and determining whether the observed activity is permissible or impermissible based on whether the computed probability falls within or outside a threshold.

### RELATED APPLICATIONS

This application claims priority to U.S. Provisional Application Ser. No. 63/745,498 filed Jan. 15, 2025, entitled “STRUCTURAL ANOMALY DETECTION USING A GENERATIVE PROCESS,” the entirety of which is incorporated by reference herein.

### FIELD

This disclosure relates to cybersecurity and anomaly detection systems. More particularly, this disclosure relates to methods and systems for detecting structural anomalies in networked systems using generative processes to model entity roles and interactions for modeling entity activities and inferring latent role variables in system logs.

### BACKGROUND

Traditional cybersecurity systems face significant limitations in detecting sophisticated and evolving threats. Signature-based detection systems can only identify known attack patterns, failing when attackers develop new techniques or modify existing ones. This inability to detect novel and evolving attacks leaves systems vulnerable to zero-day exploits and previously unseen attack vectors.

Existing signature and behavior-based methods struggle particularly with advanced persistent threats (APTs)—stealthy, multi-stage attacks that evolve dynamically over extended periods. These sophisticated attacks may appear normal when individual activities are viewed in isolation, making them difficult to detect using conventional approaches that focus on specific events or entities. Current detection systems lack the capability to identify APT activities that deviate from intended system functionality while maintaining the appearance of normal behavior.

A critical problem arises when sophisticated attackers mimic normal behavior patterns to evade detection. Traditional behavior-based detection systems that profile individual entities or events cannot distinguish between legitimate activities and malicious ones that appear similar. Most detection methods rely on profiling specific entities or events without understanding the overall functional structure and purpose of the system, making it difficult to comprehend system workflows and intended operations. Even when attackers successfully mimic normal activity patterns, they cannot change their underlying malicious purpose, which should manifest as violations of system structure and intended functionality.

Current anomaly detection methods suffer from high false alarm rates because they focus on individual events or entities in isolation, lacking context about overall system functionality. The absence of behavioral context makes it difficult for security analysts to interpret alerts and prioritize responses appropriately. Without understanding the functionality and purpose behind entity behaviors, existing systems cannot provide meaningful context about detected anomalies.

Many intrusion detection techniques require specialized system knowledge and are tailored to specific domains, limiting their applicability to complex modern environments like cloud systems and Internet of Things deployments. This reliance on domain-specific knowledge prevents the development of generic detection methodologies that could be widely applicable across different system types. Additionally, when alerts are generated, security analysts often lack meaningful context about detected anomalies, making it difficult to understand the nature of threats and prioritize responses appropriately.

In some approaches, entity-centric clustering methods such as subspace clustering have been proposed to profile entities across multiple aspects. However, these entity-centric clustering approaches may require making assumptions about subspaces or aspects for clustering entities. To avoid making unnecessary assumptions on subspaces or aspects for entity-centric clustering, an alternative approach may model around entity activities and their associations with hidden variable roles. The role of an entity may define what activities the entity performs and which other entities it interacts with. Functional role membership of entities may be treated as latent variables that drive their interactions, which are captured by entity activities as observable variables.

As attacks become more sophisticated and adversaries constantly evolve their techniques, methods focusing solely on properties of isolated events or individual system components become increasingly insufficient. The core problem is that existing intrusion detection systems cannot effectively identify sophisticated, evolving attacks that deviate from a system's intended purpose while appearing normal in their individual behaviors. There is an unmet need for detection methodologies that can analyze structure and purpose rather than just individual events, which would be better suited to deal with the evolution of attacks and provide the higher-level understanding of system functionality that is lacking in current techniques.

### SUMMARY

In one aspect, a method for structural anomaly detection comprises receiving system data comprising interaction records, each interaction record including a first entity, an activity, and a second entity; applying a generative process to compute latent variables corresponding to the first entity and the second entity, wherein the latent variables represent functional roles; computing a probability matrix based on the latent variables to quantify a likelihood of each entity performing each of the functional roles; discovering structural rules by aggregating interactions between the functional roles; comparing an observed activity from an interaction record of the interaction records against the structural rules to compute a probability of the observed activity; and determining whether the observed activity is permissible or impermissible based on whether the computed probability falls within or outside a threshold.

In some embodiments, the method further comprises grouping the interaction records by entity pairs, wherein each entity pair comprises the first entity and the second entity, and wherein grouping by entity pairs forms an activity set for each entity pair to enable the generative process to model activities between specific pairs of entities.

In some embodiments, applying the generative process comprises: computing a marginal distribution of the activity set for each entity pair by integrating over an entity-role mixture and an activity-role mixture, wherein the entity-role mixture is parameterized by a first hyperparameter that governs how the first entity and the second entity are assigned to the functional roles, and wherein the activity-role mixture is parameterized by a second hyperparameter that governs relationships between the functional roles and the activities in the activity set.

In some embodiments, the generative process includes a System Latent Dirichlet Allocation (SysLDA) generative process.

In some embodiments, computing the probability matrix comprises performing posterior inference using Gibbs sampling.

In some embodiments, the method further comprises applying a role-membership threshold to the probability matrix to determine assigned roles for entities.

In some embodiments, discovering the structural rules comprises generating a set of structural rules, each structural rule comprising a tuple indicating that a first functional role interacts with a second functional role via the activity with a probability.

In some embodiments, the method further comprises generating an alert when the observed activity is determined to be impermissible, wherein the alert includes violated structural rules, role context information, and threat priority assessment.

In some embodiments, the latent variables provide interpretable role assignments that enable tracing anomaly classifications to specific role assignments and rule violations.

In some embodiments, the latent variables provide interpretable role assignments that enable tracing anomaly classifications to specific role assignments and rule violations.

In some embodiments, applying the generative process to compute the latent variables is decoupled from determining whether the observed activity is permissible or impermissible, such that role detection is not biased toward finding anomalies.

In some embodiments, the method profiles the system holistically by modeling the roles and the role interactions rather than analyzing individual entities in isolation.

In some embodiments, determining whether the observed activity is impermissible comprises detecting malicious behavior that mimics normal usage patterns but violates the discovered rules.

In another aspect, a method for structural anomaly detection, the method comprises computing latent variables corresponding to a first entity and a second entity in a system, wherein the first entity and the second entity form an entity pair that performs a functional role; for the entity pair, computing a marginal distribution of a set of activities between the first entity and the second entity, and computing a posterior distribution of the latent variables; computing a joint distribution of an entity-role mixture for each activity in the set of activities, wherein the entity-role mixture is parameterized by a first hyperparameter, and computing an activity-role mixture parameterized by a second hyperparameter; determining a probability of the first entity and the second entity performing each of a plurality of functional roles; and determining whether an activity of the first entity and the second entity is permissible based on the probability falling within a predetermined threshold, or impermissible based on the probability falling outside of the predetermined threshold.

In some embodiments, applying the generative process comprises computing a joint distribution of an entity-role mixture parameterized by an alpha hyperparameter and an activity-role mixture parameterized by a beta hyperparameter.

In some embodiments, the generative process includes a System Latent Dirichlet Allocation (SysLDA) generative process.

In some embodiments, computing the probability matrix comprises performing posterior inference using Gibbs sampling.

In some embodiments, determining whether the observed activity is impermissible comprises detecting at least one of: a novel attack that does not match a known attack signature, or an advanced persistent threat (APT) that appears normal when examined in isolation but violates the discovered rules when analyzed in context of the role interactions.

In some embodiments, the latent variables provide interpretable role assignments that enable tracing anomaly classifications to specific role assignments and rule violations.

In some embodiments, the generative process further comprises: choosing a number of activities from a Poisson distribution; choosing an entity-role probability distribution from a Dirichlet distribution parameterized by a first hyperparameter that governs how entities are assigned to the functional roles; for each activity, choosing the role assignments for entities from a categorical distribution; and generating the activities from a multinomial distribution based on the role assignments and an activity-role mixture parameterized by a second hyperparameter that governs relationships between the functional roles and the activities.

In another aspect, a structural anomaly detection system comprises a processing module configured to receive system data comprising interaction records, each interaction record including a first entity, an activity, and a second entity, wherein the processing module applies a generative process to compute latent variables corresponding to the first entity and the second entity, wherein the latent variables represent functional roles, and wherein the generative process uses a first hyperparameter that governs how entities are assigned to the functional roles and a second hyperparameter that governs relationships between the functional roles and the activities; a structure discovery module configured to receive an entity-role probability matrix from the processing module and to discover structural rules by aggregating interactions between the functional roles; an anomaly detection module configured to compare an observed activity against the structural rules to compute a probability of the observed activity and to determine whether the observed activity is permissible or impermissible based on whether the computed probability falls within or outside a threshold; and an anomaly classification module configured to classify detected anomalies and to receive input from continuous learning capabilities to improve detection accuracy.

In another aspect, a structural anomaly detection system, comprises a processing module configured to receive system data comprising interaction records, each interaction record including a first entity, an activity, and a second entity, wherein the processing module applies a generative process to compute latent variables corresponding to the first entity and the second entity, wherein the latent variables represent functional roles, and wherein the generative process uses a first hyperparameter that governs how entities are assigned to the functional roles and a second hyperparameter that governs relationships between the functional roles and the activities; a structure discovery module configured to receive an entity-role probability matrix from the processing module and to discover structural rules by aggregating interactions between the functional roles; an anomaly detection module configured to compare an observed activity against the structural rules to compute a probability of the observed activity and to determine whether the observed activity is permissible or impermissible based on whether the computed probability falls within or outside a threshold; and an anomaly classification module configured to classify detected anomalies and to receive input from continuous learning capabilities to improve detection accuracy.

In some embodiments, the instructions further cause the system to generate an entity-role probability matrix having dimensions N×K, where N represents a number of entities and K represents a number of roles.

In some embodiments, the instructions further cause the system to apply a cutoff probability threshold δ to the entity-role probability matrix to determine whether an entity has a particular role.

In some embodiments, the SysLDA generative process comprises: choosing a number of activities H from a Poisson distribution; choosing an entity-role probability distribution θ from a Dirichlet distribution parameterized by alpha; for each activity, choosing roles for entities from a categorical distribution; and choosing an activity from a multinomial distribution based on the chosen roles and activity-role mixture parameterized by beta.

In some embodiments, the instructions further cause the system to use Gibbs sampling to compute posterior distributions of the latent variables by iteratively sampling conditional distributions of role assignments.

In some embodiments, detecting structural anomalies comprises: computing a probability of an observed activity given role assignments of participating entities; comparing the computed probability against the cutoff probability threshold δ; and classifying the activity as a structural anomaly when the probability falls below the threshold.

In another aspect, a non-transitory computer-readable storage medium storing instructions that, when executed by a processor, cause the processor to perform operations comprising: computing latent variables (z, z′) corresponding to entity pairs in a system using a System Latent Dirichlet Allocation (SysLDA) generative process; generating an entity-role probability matrix having dimensions N×K, where N represents a number of entities and K represents a number of roles; applying a cutoff probability threshold δ to the entity-role probability matrix to determine role assignments for entities; aggregating role interactions to discover structural rules governing system functionality; computing a probability of an observed activity given role assignments of participating entities; and classifying the activity as a structural anomaly when the probability falls below the cutoff probability threshold δ.

In some embodiments, the instructions further cause the system to generate an entity-role probability matrix having dimensions N×K, where N represents a number of entities and K represents a number of roles, and to apply a cutoff probability threshold δ to the entity-role probability matrix to determine whether an entity has a particular role.

In some embodiments, the SysLDA generative process comprises: choosing a number of activities H from a Poisson distribution; choosing an entity-role probability distribution θ from a Dirichlet distribution parameterized by alpha; for each activity, choosing roles for entities from a categorical distribution; and choosing an activity from a multinomial distribution based on the chosen roles and activity-role mixture parameterized by beta.

In some embodiments, the instructions further cause the system to use Gibbs sampling to compute posterior distributions of the latent variables by iteratively sampling conditional distributions of role assignments.

In some embodiments detecting structural anomalies comprises: computing a probability of an observed activity given role assignments of participating entities; comparing the computed probability against the cutoff probability threshold δ; and classifying the activity as a structural anomaly when the probability falls below the threshold.

In another aspect, a non-transitory computer-readable storage medium storing instructions that, when executed by a processor, cause the processor to perform operations comprises computing latent variables (z, z′) corresponding to entity pairs in a system using a System Latent Dirichlet Allocation (SysLDA) generative process; generating an entity-role probability matrix having dimensions N×K, where N represents a number of entities and K represents a number of roles; applying a cutoff probability threshold δ to the entity-role probability matrix to determine role assignments for entities; aggregating role interactions to discover structural rules governing system functionality; computing a probability of an observed activity given role assignments of participating entities; and classifying the activity as a structural anomaly when the probability falls below the cutoff probability threshold δ.

In some embodiments, the SysLDA generative process comprises choosing a number of activities from a Poisson distribution, choosing an entity-role probability distribution from a Dirichlet distribution parameterized by alpha, selecting roles for entities from a categorical distribution, and generating activities from a multinomial distribution based on the selected roles and an activity-role mixture parameterized by beta.

In some embodiments, the operations further comprise using Gibbs sampling to iteratively sample conditional distributions of role assignments for computing the entity-role probability matrix.

### BRIEF DESCRIPTION OF THE DRAWINGS

The above and further advantages of this invention may be better understood by referring to the following description in conjunction with the accompanying drawings, in which numerals indicate structural elements and features in various figures. The drawings are not necessarily to scale, emphasis instead being placed upon illustrating the principles of the invention. In the drawings:

FIG. 1 illustrates a structural anomaly detection system architecture, according to aspects of the present disclosure.

FIG. 2 illustrates a flowchart of a method for structural anomaly detection, according to aspects of the present disclosure.

FIG. 3 illustrates a graphical representation of a SysLDA generative process, according to aspects of the present disclosure.

FIG. 4 illustrates an entity-role probability matrix, according to aspects of the present disclosure.

FIG. 5 depicts a structure discovery illustration showing detected roles and probabilistic interactions, according to aspects of the present disclosure.

### DETAILED DESCRIPTION

The following description sets forth exemplary aspects of the present disclosure. It should be recognized, however, that such description is not intended as a limitation on the scope of the present disclosure. Rather, the description also encompasses combinations and modifications to those exemplary aspects described herein.

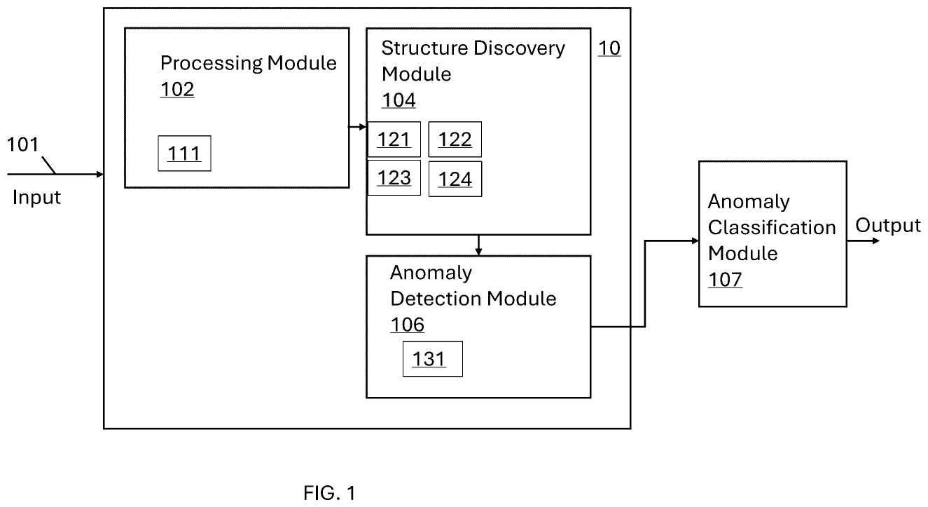

Referring to FIG. 1, a structural anomaly detection system architecture 10 is configured to identify malicious or unwanted behaviors in systems that deviate from intended functionality. In some embodiments, the system architecture 10 comprises a processing module 102, a structure discovery module 104, an anomaly detection module 106, and an anomaly classification component 107.

The processing module 102 is constructed and arranged to receive system data 101 (e.g., system logs but not limited thereto) and several categories of inputs that enable role modeling and anomaly detection. As used herein, the term “processing module” refers to a computational component configured to receive and process system data to identify functional roles and structural patterns within a computer system. As used herein, the term “functional roles” refers to latent variables representing hidden or unobserved factors that define what activities entities perform and which other entities they interact with within a system. Functional role membership of entities are latent variables that drive their interactions, which are captured by entity activities as observable variables. Functional roles are not directly present in system logs but are inferred from entity behavioral patterns and interaction characteristics. Functional roles may abstract entities into behavioral categories, enabling the system to identify when an entity acts outside its expected role. Examples of functional roles may include database administrators, users, servers, or other categories that characterize entity behaviors within the monitored system.

The processing module 102 may encompass one or more sub-modules including a role detection module that applies a generative model to infer latent role assignments for entities, a structure discovery module that analyzes interactions between detected roles to extract structural rules, and other components that transform raw system data into role assignments and structural patterns. The processing module 102 may receive various types of input data including system logs, activity records, event data, and other forms of system data that capture entity interactions within the monitored system.

The system data 101 refers to any data that captures interactions, activities, or events occurring within a computer system or network, including but not limited to system logs, audit records, event logs, network traffic data, application logs, database transaction records, user activity records, authentication records, file access records, and telemetry data. The system data 101 may include user login events, file access records, network connections, and database queries. Each entry within the system data 101 may be represented as an entity-activity-entity tuple (eₙ, a, eₘ), where eₙ represents a first entity (such as a user account, server, process, or network device), a represents an activity type (such as file access, network connection, database query, or login event), and eₘ represents a second entity (such as a file, database, network resource, or target system). The system data 101 may be organized by entity pairs, where d_{n,m} represents the set of all activities between a specific entity pair (eₙ, eₘ).

In some embodiments, the processing module 102 receives hyperparameters that control the probabilistic distributions within a SysLDA (System Latent Dirichlet Allocation) generative model. The hyperparameter alpha (α) controls the entity-role distribution, which governs how entities are assigned to functional roles within the system. The hyperparameter beta (β) controls the role-activity distribution, which governs the relationship between role pairs and the activities they perform. These hyperparameters serve as Dirichlet priors in the SysLDA model and influence the sparsity and concentration of the resulting probability distributions.

In some embodiments, the processing module 102 also receives a role count parameter K, which specifies the number of latent functional roles to be identified within the system. The role count K determines the dimensionality of the entity-role probability matrix and influences the granularity of role assignments.

In some embodiments, the processing module 102 also receives threshold parameters used for classification decisions. A cutoff probability threshold (δ) determines whether an entity has sufficient probability of belonging to a particular role to be assigned that role membership. A permissibility threshold determines whether an observed activity between entities with specific role assignments is considered normal or anomalous based on the learned structural rules.

The processing module 102 may include a SysLDA generative model component 111, which initiates the role detection process by probabilistically inferring functional role assignments from system data 101, modeling entity activities as observable variables within a latent role framework. SysLDA infers latent variables (z, z′) that represent functional roles performed by entity pairs and computes entity-role probability distributions. For example, z represents a functional role of the first entity (eₙ) of an entity pair, and z′ represents a functional role of the second entity (eₘ). In certain embodiments, the processing module 102 generates an entity-role probability matrix, denoted as P_{ER}, with dimensions N×K during the SysLDA inference process, where N corresponds to the total number of entities and K denotes the set of possible roles. In particular, the entity-role probability matrix P^{ER} is a global matrix summarizing probabilities for all entities after inference. The entity-role probability matrix P^{ER} can be provided to the structure discovery module 104 for subsequent structure discovery and anomaly detection processes.

The structure discovery module 104 is configured to analyze and extract interaction patterns among functional roles within the system. In particular, the structure discovery module 104 utilizes outputs generated by the SysLDA generative component 111, including inferred role assignments and associated probability distributions, to identify relationships between roles based on observed entity interactions. The module 104 can aggregate these role-to-role interactions across system activities to derive structural rules that define permissible interactions between roles. These structural rules represent the normative functional architecture of the system and serve as a baseline for subsequent anomaly detection operations. By modeling the system's functional structure at the role level, the structure discovery module 104 enables detection of deviations indicative of structural anomalies or intrusions.

In some embodiments, the structure discovery module 104 receives the entity-role probability matrix and role assignments generated by SysLDA 111 and comprises a role interaction aggregation component 121 and a rule mining engine 122 that work together to extract structural patterns from the system data. The role interaction aggregation component 121 is configured to aggregate system logs to identify activities between role pairs and determine their correlation strengths, enabling the system to understand interaction patterns at the community level based on the probabilistic role assignments. The rule mining engine 122 extracts rules governing the functional structure of the system based on the aggregated role interactions, correlation strengths, and the structural patterns discovered through the SysLDA-generated role distributions.

The structure discovery module 104 may further include a structural pattern extraction component 123 that identifies patterns in how roles interact with one another within the system by analyzing the correlation strengths between role pairs. A system functional rules component 124 may generate rules that define the permissible interactions and behaviors within the system based on the discovered structural patterns and correlation strengths. These functional rules may serve as a baseline for determining normal system behavior and identifying deviations that may indicate anomalous activities.

The anomaly detection module 106 is configured to identify potential structural deviations by comparing observed system behaviors against functional structure rules derived during structure discovery. In particular, the anomaly detection module 106 includes a structural rules component 131 that applies these rules to perform structural comparisons between observed activities and established norms. The module 106 detects anomalies by identifying activities executed by entities in roles that are not permitted according to the discovered functional structure. Role-activity validation is performed to verify whether observed role assignments and associated activities conform to expected patterns, wherein any activity conducted by an entity in a disallowed role is flagged as anomalous. Additionally, the module 106 performs probability-based evaluation by comparing the likelihood of observed activities against predefined threshold conditions to determine whether such activities fall within acceptable ranges based on learned structural patterns.

The anomaly detection module 106 may further incorporate continuous learning and adaptive model update capabilities to accommodate evolving system behaviors and emerging threat patterns. A continuous learning component can receive feedback from security analysts regarding anomaly detection accuracy and utilize this feedback to refine structural rules and probability thresholds. The model update process may periodically retrain the SysLDA generative model 111 using accumulated system logs, thereby updating entity-role probability distributions and structural patterns to reflect legitimate changes in system behavior over time.

In some embodiments, the system 10 includes the anomaly classification component 107 configured to improve detection accuracy and reduce false positives by incorporating input from continuous learning and model update processes from the anomaly detection module 106. As new system data such as logs 101 are collected and analyzed, the anomaly classification component 107 may adjust its classification criteria based on updated entity-role probability matrices and refined structural rules. The model update process may implement incremental learning techniques to incorporate new information without requiring complete retraining of the generative model 111, while triggering comprehensive retraining when significant changes in system structure or entity behaviors are detected. The continuous learning component may track performance metrics such as false positive rates, false negative rates, and analyst feedback to refine structural rules and probability thresholds. The anomaly detection module 106 may further include a threshold determination component configured to establish and adapt probability thresholds used for anomaly classification. Initially, the threshold may be calibrated based on historical system logs by computing likelihood distributions for normal activities and selecting a cutoff value corresponding to a predefined percentile or confidence interval. During operation, the threshold determination component evaluates the probability of an observed activity given inferred role assignments and structural rules, classifying the activity as permissible when the computed likelihood satisfies the threshold condition and as anomalous when it falls below the threshold. To improve accuracy and reduce false positives, the threshold may be dynamically adjusted, or tuned, through continuous learning processes that incorporate analyst feedback and performance metrics such as false positive and false negative rates. In some embodiments, the threshold determination component may implement adaptive algorithms that increase the threshold when benign anomalies are confirmed and decrease the threshold when missed anomalies are identified. This adaptive capability enables the system to maintain robust anomaly detection performance as legitimate behaviors evolve and new threat patterns emerge. The anomaly classification component 107 may utilize updated models to reassess previously flagged activities, reclassifying certain anomalies as normal behaviors if structural rules indicate permissibility. Additionally, continuous learning capabilities may enable detection of emerging attack patterns by identifying clusters of similar anomalies indicative of coordinated malicious activities or new attack vectors.

The anomaly classification component 107 may include an alerting subsystem configured to generate notifications when anomalies are classified as impermissible. The alerting subsystem can compile relevant details such as the entities involved, the activity flagged, the inferred roles, and the associated probability score. Alerts may be transmitted to a security dashboard, log management system, or designated personnel via secure communication channels. In some embodiments, alerts may be prioritized based on severity and integrated with automated response workflows to initiate mitigation actions such as isolating compromised entities or blocking suspicious activities. The system 10 may provide meaningful context for security analysts by presenting anomalies within the framework of understood system roles and interactions. The system 10 may identify malicious intent through structural analysis that focuses on deviations from intended functionality rather than just unusual individual behaviors. The system 10 may detect novel and zero-day attacks that do not match known attack signatures by focusing on structural violations rather than specific attack patterns. The structural anomaly detection system 10 may be configured to identify advanced persistent threats (APTs) that appear normal when examined in isolation but violate structural rules when analyzed in the context of system-wide role interactions. The system 10 may reduce false alarms through contextual analysis that considers the broader functional context of observed activities rather than flagging activities based solely on statistical outliers or individual entity behaviors.

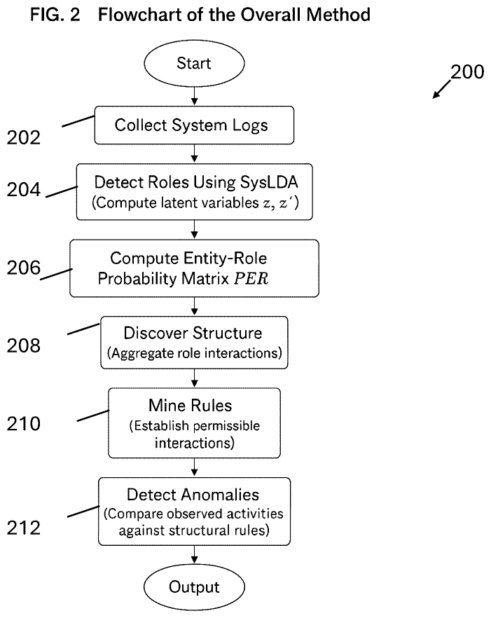

FIG. 2 illustrates a flowchart of a method 200 for structural anomaly detection, according to aspects of the present disclosure. In describing the method 200, reference is made to elements of FIG. 1. The method 200 may be implemented through a sequential process that transforms raw system logs 101 into actionable anomaly detection results.

The method 200 may begin at step 202 by collecting system logs that contain entity-activity-entity tuples representing interactions within the monitored system. These system logs may serve as the foundational input data for the entire structural anomaly detection process. The system logs may be collected from various sources including network devices, servers, databases, applications, and security systems operating within the monitored environment. In some embodiments, each entity-activity-entity tuple may comprise a first entity (eₙ) that initiates or performs an action, an activity (a) that represents the specific operation or interaction being performed, and a second entity (eₘ) that serves as the target or recipient of the activity. The first entity and second entity may represent various system components such as user accounts, computer systems, network devices, files, databases, applications, or any other identifiable elements within the system architecture. The activities captured in the logs 101 may include but are not limited to user authentication events, file access operations, network connection attempts, database queries, system administration commands, data transfer operations, and application-specific interactions. The collection process may involve real-time monitoring of system activities, periodic log aggregation from distributed sources, or batch processing of historical log data depending on the specific implementation requirements and operational constraints of the monitored environment. The tuples are reorganized so that all activities between the same pair of entities are grouped together. This forms a set d_{n,m} for each entity pair (eₙ, eₘ).

The method may proceed to step 204, where the SysLDA generative component 111 is used to detect roles by computing latent variables (z, z′) that represent the functional roles performed by entity pairs within the monitored system. The SysLDA process may model entity activities as observable variables generated through a probabilistic generative process, where the latent variables z and z′ represent functional roles assigned to entity pairs based on their behavioral patterns and interaction characteristics. The computation of these latent variables may involve sampling from probability distributions that capture the underlying functional structure of the system, enabling the identification of roles that entities perform based on their observed activities and interactions. The SysLDA generative component 111 may begin by choosing a number of activities H from a Poisson distribution parameterized by ξ, followed by choosing an entity-role probability distribution θ from a Dirichlet distribution parameterized by alpha. For each activity within the system logs 101, the process performed by the SysLDA component 111 may choose roles for the first entity (eₙ) and second entity (eₘ) from a categorical distribution based on their respective entity-role probability distributions. Subsequently, the process may choose an activity from a multinomial distribution based on the chosen roles and an activity-role mixture parameterized by beta. The latent variables z and z′ may be inferred through iterative sampling techniques such as Gibbs sampling, which computes posterior distributions by iteratively sampling conditional distributions of role assignments for each activity in the entity-activity-entity tuples. This inference process may enable the system to discover the probabilistic relationships between entities and their functional roles, providing a foundation for understanding the structural organization of the monitored system and identifying deviations from normal operational patterns.

The method at step 206 may advance to compute an entity-role probability matrix P^{ER} that quantifies the likelihood of each entity performing specific roles within the system. The entity-role probability matrix may have dimensions N×K, where N represents the number of entities in the system and K represents the number of identified roles. Each element in the matrix may indicate the probability that a particular entity belongs to a specific functional role, providing a quantitative foundation for understanding entity behaviors and role assignments. The computation of the entity-role probability matrix P^{ER} may be derived from the SysLDA inference process, where each matrix element P^{ER}(n,i) represents the probability that the n-th entity performs the i-th role.

The entity-role probability matrix may serve as a fundamental data structure that transforms the discrete role assignments generated by the SysLDA process into continuous probability distributions. Each row of the matrix may correspond to a specific entity in the system, while each column may represent one of the K functional roles identified during the role detection phase. The probability values within the matrix may range from 0 to 1, with higher values indicating stronger associations between entities and their respective roles. The matrix computation process may account for the multi-role nature of entities within complex systems, where individual entities may perform multiple functional roles with varying degrees of probability. This probabilistic approach may enable the system to capture nuanced behavioral patterns that would be lost in binary role assignment schemes.

The method 200 may then proceed at step 208 to discover structure by the structure discovery module 104 by aggregating role interactions to extract patterns and relationships between the identified functional roles. This structure discovery process may analyze how different roles interact with one another, identifying correlation strengths and interaction patterns that define the normal operational structure of the system. The aggregation of role interactions may reveal the underlying functional architecture that governs legitimate system behaviors and entity relationships.

With continued reference to FIG. 2, the method 200 at step 210 may mine rules by the rule mining engine 122 to establish permissible interactions within the system based on the discovered structural patterns. The rule mining process may extract specific rules that define which role-to-role interactions are considered normal and acceptable within the system's functional structure. These rules may serve as a baseline for distinguishing between legitimate activities and potential anomalies, providing a framework for evaluating observed behaviors against established norms.

The method 200 may conclude at step 212 by executing the anomaly detection module 106 to detect anomalies through comparing observed activities against the established structural rules to identify deviations from expected behavior patterns. This comparison process may evaluate whether new or ongoing activities conform to the mined rules and structural patterns, flagging activities that violate the established functional structure as potential anomalies. The anomaly detection may focus on structural violations rather than individual behavioral outliers, enabling the identification of sophisticated attacks that may appear normal when examined in isolation but violate the system's intended functional architecture.

The sequential nature of the method 200 shown in FIG. 2 may enable comprehensive analysis of system behaviors by first establishing a baseline understanding of normal functional roles and interactions, then using this baseline to identify activities that deviate from expected structural patterns. This approach may provide enhanced detection capabilities for advanced threats that attempt to blend in with normal system operations while pursuing malicious objectives.

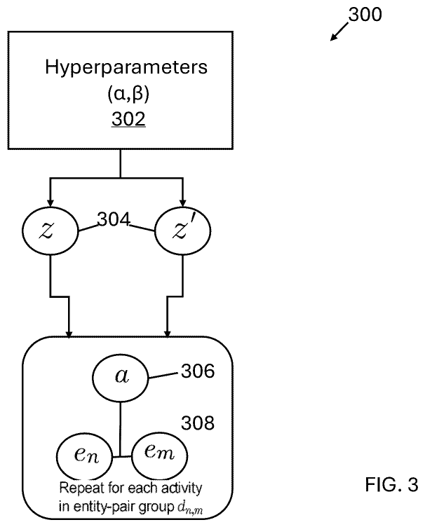

Referring to FIG. 3, a graphical representation of the SysLDA generative process 300 illustrates the hierarchical structure and probabilistic relationships between hyperparameters alpha (α) and beta (β) 302, latent role variables (z, z′) 304 representing functional roles assigned to entities, observable activity variables (a) 306, and entity pairs (eₙ, eₘ) 308. At the top level of the model hierarchy, hyperparameter alpha (α) controls the entity-role distribution, or entity-role mixture theta (θ), which governs how entities are assigned to functional roles within the system, where a large a is indicative of a more uniform distribution and a small a is indicative of a more skewed distribution. The hyperparameter beta (β) governs the activity-role mixture phi (φ), which controls the distribution of activities associated with role pairs. These hyperparameters 302 parameterize the Dirichlet distributions from which the entity-role and activity-role mixtures are sampled. The latent variables 304 (z and z′) represent the functional roles assigned to entities within the system and are referred to as “latent” variables because they represent hidden or unobserved factors, in this case, the roles of entities, that are not directly present in the system logs. The latent variable z represents the role of the first entity eₙ, and the latent variable z′ represents the role of the second entity eₘ, with both variables independently sampled from the entity-role probability distribution θ. Within the rectangular box representing the generative process for each entity pair, an observable variable 306 (a) is positioned at the top, representing the activities performed between entities. Two entity pair variables 308 (eₙ and eₘ) are positioned below the observable variable a, connected by a horizontal line indicating their relationship as an interacting entity pair. The directed arrows from the latent variables (z, z′) 304 into the box indicate that the role assignments influence the generation of activities between the entity pairs. This graphical structure provides the foundation for the mathematical formulation of the SysLDA generative process, which specifies the probability distributions and dependencies that govern how system logs are generated from the underlying role structure.

The mathematical formulation of the SysLDA generative process may begin with a representation of system logs. In some embodiments, the system logs L may be represented as:

$$L = \{ {a}_{h} ∈ A , {e}_{n} , {e}_{m} ∈ E \} \qquad ( 1 )$$

where eₙ represents a first entity of the entity pair 308, aₕ represents an activity, eₘ represents a second entity of the entity pair 308, A represents the set of all activities, and E represents the set of all entities. This representation captures the entity-activity-entity tuples that form the foundational data for the structural anomaly detection process.

The system logs L may be regrouped by entity pair to facilitate the generative modeling process. The regrouped representation may be expressed as:

$$L = \{ ∀ ( n , m ) , ∃ ( {e}_{n} , a , {e}_{m} ) ∈ L , a ∈ V \} \qquad ( 2 )$$

where d_{n,m} represents the set of activities between a specific entity pair. The set d_{n,m} may be defined as:

$${d}_{n , m} = \{ ∀ a ∈ V , ( {e}_{n} , a , {e}_{m} ) ∈ L , {e}_{n} ∈ E , {e}_{m} ∈ E \} . \qquad ( 3 )$$

where V represents the vocabulary of activity types observed in the system logs. This regrouping organizes the system logs by entity pairs, enabling the generative process to model activities between specific pairs of entities.

The generative process may proceed through a series of steps for each of M entity pairs (eₙ, eₘ) or d_{n,m} in the system logs L. In some embodiments, the method may use a Poisson distribution to choose the number of activities H for each entity pair, expressed as H~Poisson(ξ), where represents the rate parameter of the Poisson distribution. The system may model entity-role probability distribution using a Dirichlet distribution with hyperparameter alpha, expressed as θ~Dir(α), where θ controls the entity-role probability distribution that governs role assignments for entities within the system.

For each of the H activities aₕ, the generative process may select roles for the first entity eₙ and the second entity eₘ from categorical distributions. The role zₕ for the first entity eₙ may be chosen as zₕ~Categorical (θ,K), where K represents the number of roles in the system. Similarly, the role z′ₕ for the second entity eₘ may be chosen as z′ₕ~Categorical(θ,K). The method may model activity-role distribution using hyperparameter beta that controls role distribution for entity activities. The activity ah may then be chosen from a multinomial distribution based on the selected roles and the activity-role mixture, expressed as:

$${a}_{h} ∼ Multinorminal ( {z}_{h} , {z}_{h}^{′} , β ) \qquad ( 4 )$$

The method may calculate joint probability of role assignment using a 1-of-K² categorical distribution. The joint distribution of entity-role mixture θₐ, activity-role mixture φ, role assignments z and z′, and activity a may be expressed as:

$$p ( α , β ) = p ( α ) p ( β ) p ( {θ}_{a} ) p ( z , {z}^{′} , ϕ ) \qquad ( 5 )$$

This joint distribution captures the probabilistic dependencies between the hyperparameters, latent variables, and observable variables in the SysLDA model 111. The term p(θₐ|α) represents the probability of the entity-role mixture given the hyperparameter alpha. The term p(φ|β) represents the probability of the activity-role mixture given the hyperparameter beta. The term p(z, z′|θₐ) represents the probability of the role assignments given the entity-role mixture. The term p(a|z, z′, φ) represents the probability of the activity given the role assignments and the activity-role mixture.

The marginal distribution of activities and role assignments given the hyperparameters may be obtained by integrating over the entity-role mixture θₐ and the activity-role mixture φ. The marginal distribution may be expressed as:

$$p ( α , β ) = \int \int p ( β ) p ( α ) ( p ( {θ}_{d} ) p ( z , {z}^{′} , ϕ ) ) d {θ}_{a} d ϕ \qquad ( 6 )$$

This marginal distribution enables the computation of posterior distributions of the latent variables z and z′ given the observed activities and hyperparameters. The integration over the entity-role mixture and activity-role mixture removes these intermediate variables from the distribution, providing a direct relationship between the observed activities, role assignments, and hyperparameters that govern the generative process.

The computation of the marginal distribution for entity pairs may be derived by summing over all H activities a∈d and the role assignments (z, z′) for each entity pair (eₙ, eₘ). The marginal distribution of d for an entity pair (eₙ, eₘ) may be expressed as:

$$( α , β ) = \int \int p ( β ) p ( α ) ( {\prod }_{h = 1}^{{H}_{d}} \sum p ( {θ}_{a} ) p ( {z}_{h} , {z}_{h}^{′} , ϕ ) ) d {θ}_{a} d ϕ \qquad ( 7 )$$

The marginal distribution captures the probability of observing the set of activities d_{n,m} between a specific entity pair given the hyperparameters alpha and beta. The system integrates over the entity-role mixture theta (θₐ) and the activity-role mixture phi (φ) parameters to obtain marginal distributions for entity pairs. The integration removes the intermediate distributional parameters from the expression, yielding a distribution that depends directly on the observed activities and the hyperparameters that govern the generative process. The product term Πh=1H_{d} iterates over all H_{d} activities associated with the entity pair, while the summation term Σzₕ,z′ₕ marginalizes over all possible role assignments for each activity.

The probability of the whole set of system logs L may be computed as a product of the marginal probabilities of individual entity pairs. The probability of the complete log set may be expressed as:

$$p ( α , β ) = {\prod }_{d = ( n , m )}^{M ϵ N \times N} \int \int p ( α ) p ( β ) ( {\prod }_{h = 1}^{{H}_{d}} {\sum }_{{z}_{h} , {z}_{h}^{′}} p ( {θ}_{a} ) p ( {z}_{h} , {z}_{h}^{′} , ϕ ) ) d {θ}_{a} d ϕ \qquad ( 8 )$$

The product over d=(n, m) iterates through all M entity pairs in the set N×N, where N represents the set of entities in the system. Each term in the product represents the marginal probability of the activities observed between a specific entity pair, computed by integrating over the theta and phi parameters as described above. The multiplication of these marginal probabilities yields the joint probability of observing the entire set of system logs given the hyperparameters alpha and beta.

The goal of this SysLDA model above is to compute the posterior distribution of the latent variables given the observed system logs. The posterior distribution may be expressed as p(α,β|L)∝p(L|α,β), indicating that the posterior distribution of the hyperparameters alpha and beta given the observed logs L is proportional to the likelihood of the logs given those hyperparameters. The computation of the posterior distribution enables the inference of the latent role assignments and structural patterns that best explain the observed entity activities within the system. The posterior distribution provides a probabilistic framework for understanding the functional roles performed by entities and the structural relationships that govern their interactions, forming the foundation for subsequent structure discovery and anomaly detection processes.

The inference of posterior distributions in the SysLDA model 111 may be intractable for exact computation due to the coupling of the entity-role mixture θ and the activity-role mixture parameter β in the summation over latent variables. The coupling between these parameters creates computational dependencies that prevent closed-form solutions for the posterior distributions. To address this intractability, the system may employ Gibbs sampling as an approximating inference algorithm that enables successively sampling conditional distributions of variables. Gibbs sampling represents a Markov chain Monte Carlo type method, that iteratively samples from conditional distributions to approximate the target posterior distribution.

The Gibbs sampling algorithm may operate by iterating conditional sampling for each activity aₜ ∈V, where t=1 . . . T represents the index over activity types in the vocabulary V. Each step of the sampling process may replace the value of the role assignment (zₜ, z′ₜ) with a value drawn from the distribution of that variable aₜ conditioned on values of remaining variables a_{¬t}. The sampling process assumes that the role assignments z_{¬t} and z′_{¬t} for the remaining variables are correct, enabling iterative refinement of role assignments across all activities in the system logs.

The conditional probability for role assignment may be expressed as the probability of being associated with a role pair (zₜ, z′ₜ) conditioned on the values of remaining variables. This conditional probability may be formulated as:

$$p ( {z}_{¬ t} , {z}_{¬ t}^{′} , a , α , β ) ∝ \frac{p ( a , α , β )}{p ( α , β )} ∝ p ( α , β ) \qquad ( 9 )$$

The proportionality relationship indicates that the conditional probability of the role assignment for activity t given all other role assignments is proportional to the joint probability of all role assignments and activities given the hyperparameters alpha and beta. This formulation enables the Gibbs sampler to draw samples from the conditional distribution by computing the joint probability for each possible role assignment and normalizing across all possibilities.

The joint probability p(a, z, z′|α, β) may be decomposed by summing over all activities a∈d, yielding a factorized form that separates the entity-role and activity-role components. The decomposition may be expressed as:

$$p ( α , β ) = \int p ( α ) p ( {θ}_{a} ) d {θ}_{a} \int p ( β ) p ( z , {z}^{′} , ϕ ) d ϕ \qquad ( 10 )$$

This decomposition separates the joint probability into two independent integrals: one involving the entity-role mixture θₐ and the role assignments, and another involving the activity-role mixture φ and the observed activities. The separation enables independent computation of each integral, simplifying the overall inference process.

The method 200 may maintain count matrices to track role assignments throughout the inference process. An entity-role count matrix C^{ER} may be maintained as a set of K×K count matrices for every entity pair (eₙ, eₘ) where there exists an activity (eₙ, a, eₘ)∈L. The entity-role count matrix C^{ER}_{n,m} may hold the number of times an entity pair is assigned to all possible role combinations (i, j), where C^{ER}_{n,m}(i, j) represents the number of activities when the entity pair (eₙ, eₘ) is assigned to roles i and j respectively. In other words, the entity-role count matrix C^{ER} is a K×K count matrix that records how many times a pair of entities (eₙ,eₘ) has been assigned to a specific pair of roles (i,j) during inference or sampling.

In some embodiments, an activity-role count matrix C^{AR} may be maintained as a set of J activity-role K×K count matrices for every activity type. The activity-role count matrix C^{AR}ₐₜ may record the number of times activity aₜ, where t∈[1, T], is assigned to an entity pair of role (i, j). The element C^{AR}ₐₜ(i, j) represents the number of times activity aₜ has been associated with an entity pair having roles i and j.

The first integral involving the entity-role mixture may be evaluated to yield a closed-form expression based on the entity-role count matrix. The integration result may be expressed as:

$$\int p ( α ) p ( {θ}_{a} ) d {θ}_{a} = \frac{{c}_{n , m}^{E R} ( i , j ) + α}{{\sum }_{i , j} {c}_{n , m}^{E R} ( i , j ) + K α} \qquad ( 11 )$$

This expression indicates that the probability of activity being associated with role pair (i, j) may be estimated by the proportion of activities of the given entity pair (eₙ, eₘ) being assigned to the role combination (i, j). The numerator comprises the count of activities assigned to role pair (i, j) plus the smoothing parameter alpha. The denominator comprises the sum of all counts across all role combinations plus K times alpha, where K represents the number of roles. As more activities are associated with role combination (i, j), the current activity a becomes more likely to be initiated by entities of the i-th role and j-th role.

The second integral involving the activity-role mixture may be evaluated to yield a closed-form expression based on the activity-role count matrix. The integration result may be expressed as:

$$\int p ( β ) p ( z , {z}^{′} , ϕ ) d ϕ = \frac{{c}_{{a}_{t}}^{A R} ( i , j ) + β}{{\sum }_{t}^{T} {c}_{{a}_{t}}^{A R} ( i , j ) + T β} \qquad ( 12 )$$

This expression represents the probability of an activity occurring given the roles of the entities, calculated by the proportion of this type of activity associated with role pair (i, j). The numerator comprises the count of activity type aₜ assigned to role pair (i, j) plus the smoothing parameter beta. The denominator comprises the sum of all activity counts for role pair (i, j) across all activity types plus T times beta, where T represents the total number of activity types. This probability indicates how likely an event (eₙ, a, eₘ) occurs with entities eₙ and eₘ having roles i and j assigned.

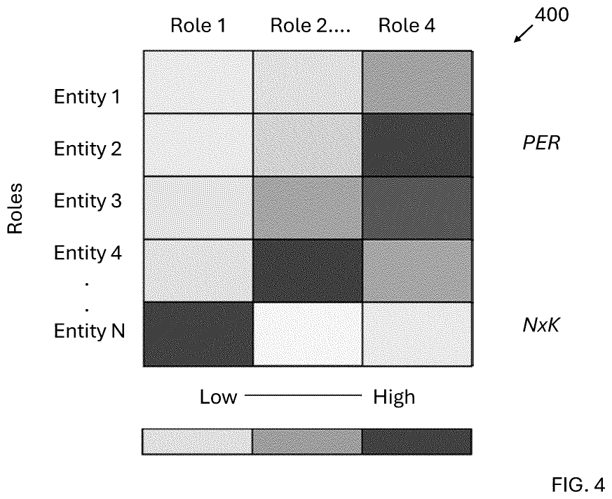

Referring to FIG. 4, an entity-role probability matrix 400 may be generated having dimensions N×K, where N represents the number of entities in the system and K represents the number of functional roles identified through the SysLDA process. The matrix 400 may serve as a quantitative representation of the likelihood that each entity performs specific roles within the monitored system, providing a probabilistic foundation for understanding entity behaviors and role assignments.

The computation of entity role probability may be performed using the formula (13) where p_{n,i} represents the probability that the n-th entity performs the i-th role.

$${p}_{n , i} = \frac{{w}_{n , i}}{{\sum }_{k = 1}^{K} {w}_{n , k}} where , \qquad ( 13 )$$

$${w}_{n , i} = \frac{{\sum }_{m = 1}^{N} {\sum }_{j = 1}^{K} ( {C}_{n , m}^{E R} [ i ] [ j ] + {C}_{m , n}^{E R} [ j ] [ i ] )}{{\sum }_{m = 1}^{N} {\sum }_{i = 1 , j = 1}^{K} ( {C}_{n , m}^{E R} [ i ] [ j ] + {C}_{m , n}^{E R} [ j ] [ i ] )}$$

where C^{ER}_{n,m} represents the entity-role count matrix that records the number of times entity pair (n,m) is assigned to specific role combinations.

The computation process may aggregate role assignments across all entity pairs and role combinations to determine the relative frequency with which each entity participates in specific functional roles. The numerator of the weighted count formula may sum over all entities m and roles j to capture both direct role assignments C^{ER}_{n,m}[i][j] where entity n performs role i, and symmetric role interactions C^{ER}_{m,n}[j][i] where entity n participates as the second entity in role i. The denominator may normalize these counts across all possible role combinations to ensure that the resulting probabilities form a valid probability distribution

As shown in FIG. 4, the computation may result in a K-dimensional vector pₙ=(p₁, p₂, . . . , p_{K}) for each entity n in the system. Each element of this vector may represent the probability that the corresponding entity performs a specific role, with the sum of all elements in the vector equaling 1 to maintain the properties of a valid probability distribution. The K-dimensional vectors for all entities may be combined to form the complete entity-role probability matrix P^{ER}.

The entity-role probability matrix P^{ER} 400 may be structured as an N×K matrix where each element satisfies the constraint 0<P^{ER}(n,i)=p_{n,i}<1, with n ranging from 1 to N representing the entity index and i ranging from 1 to K representing the role index. The matrix 400 may contain probability values that quantify the strength of association between each entity and each functional role, enabling the system to capture multi-role behaviors where individual entities may participate in multiple functional roles with varying degrees of likelihood.

As further shown in FIG. 4, the probability values within the matrix 400 may be displayed according to a color scale that provides visual representation of the probability distributions. The color scale may range from low probability values, shown in light gray, through medium probability values, to high probability values, shown in dark gray. This visual encoding may enable rapid identification of strong entity-role associations and patterns within the probability matrix, facilitating analysis of role distributions across the monitored system.

The matrix representation shown in FIG. 4 may illustrate varying probability distributions across different entity-role combinations, demonstrating how different entities may exhibit different patterns of role membership. For example, Entity 2 and Entity 3 may show higher probabilities for Role 4, Entity 1 may show higher probability for Role 2, and Entity N may show higher probability for Role 1, reflecting the diverse functional roles that entities may perform within the system architecture. These probability patterns may provide insights into the functional organization of the system and serve as the foundation for subsequent structure discovery and anomaly detection processes.

The following table summarizes the notation used in the SysLDA generative process and entity-role probability computations described herein:

TABLE 1

| Notation | Comment |
|---|---|
| α | hyper-parameter that sets the role distribution for entity pairs |
| β | hyper-parameter that sets the role distribution for entity activities |
| C^{AR} | a set of J activity-role K × K count matrix for every activity type. |
| ${C}_{{a}_{t}}^{AR}$ | count matrix K × K of aₜ that records number of times aₜ, t ∈ [1, T] being assigned to entity pair of role (i, j). |
| ${C}_{{a}_{h}}^{A R} ( i , j )$ | the number of times aₕ being associated with entity pair of role (i, j). |
| C^{ER} | a set of entity-role K × K count matrix, for every pair |
| | (eₙ, eₘ), ∃ (eₙ, a, eₘ) ∈ L |
| ${C}_{n , m}^{E R}$ | the count K × K matrix that holds number of times entity pair assigned to all possible role combinations (i, j) |
| ${C}_{n , m}^{E R} ( i , j )$ | the number of activities when (eₙ, eₘ) is assigned to role i, j. |

The entity-role probability matrix P^{ER} may be transformed into an indicator matrix I_{N×K} using a cutoff probability threshold δ to determine whether an entity has a specific role. The transformation process may convert the continuous probability values in the entity-role probability matrix into binary indicators that provide discrete role assignments for each entity in the system. The indicator matrix I_{N×K} may have the same dimensions as the entity-role probability matrix, with N representing the number of entities and K representing the number of functional roles.

The transformation from the probability matrix to the indicator matrix may be performed according to the following rule:

$${I}_{n , k} \{ 0 if {P}^{E R} ( n , k ) >= δ1 otherwise \qquad ( 14 )$$

This formulation indicates that an entity eₙ may be determined to have the k-th role when the probability value P^{ER}(n,k) exceeds the cutoff probability threshold δ. The cutoff probability threshold δ may serve as a tunable parameter that controls the sensitivity of role assignment, with lower threshold values resulting in more entities being assigned to roles and higher threshold values resulting in more selective role assignments.

The n-th row of the indicator matrix, denoted as Iₙ, may represent the role membership vector for entity eₙ. Each element of the row vector Iₙ may indicate whether the corresponding entity has been assigned to a particular role based on the cutoff threshold comparison. The role membership vector Iₙ may contain binary values where a value of 1 indicates that the entity has the corresponding role (probability exceeds threshold) and a value of 0 indicates that the entity does not have the corresponding role (probability falls below threshold).

The indicator matrix representation may enable the system to capture multi-role behaviors where individual entities may be assigned to multiple functional roles simultaneously. An entity may have multiple roles when multiple elements in its corresponding row vector Iₙ contain values of 1, indicating that the entity's probability of performing those roles exceeds the cutoff threshold δ. The selection of the cutoff probability threshold δ may influence the granularity of role assignments and the degree to which entities are permitted to participate in multiple functional roles within the system structure.

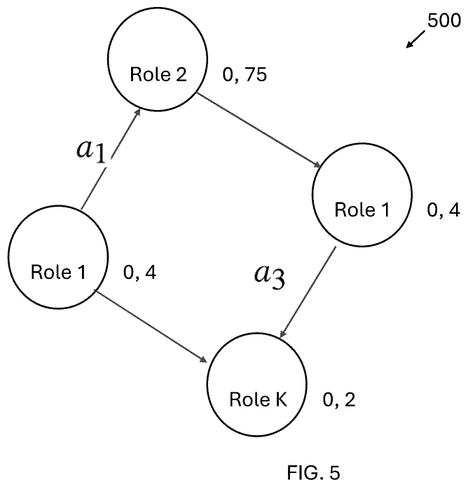

FIG. 5 illustrates a structure discovery process showing detected functional roles and their probabilistic interactions, where nodes represent roles (Role 1, Role 2, Role k) with associated probability values, and edges labeled with activities (a1, a3) represent the structural rules governing permissible role-to-role interactions within the system.

Referring to FIG. 5, a structure discovery illustration depicts detected roles and probabilistic interactions within a system. The illustration includes four circular nodes representing different functional roles: a Role 2 node positioned at the top with an associated probability value of 0.75, a Role 1 node on the left side with a probability value of 0.4, another Role 1 node on the right side with a probability value of 0.4, and a Role k node at the bottom with a probability value of 0.2. The Role 2 node may connect to the left Role 1 node via an edge labeled a1, and may connect to the right Role 1 node via a directed arrow. The left Role 1 node may connect to the Role k node via a directed arrow, and the right Role 1 node may connect to the Role k node via an edge labeled a3. The numerical values adjacent to each node may represent probabilistic weights or interaction strengths associated with the respective roles.

The structure discovery process may determine entity roles for a first entity eₙ and a second entity eₘ given an event (eₙ, a, eₘ) by calculating the probability of role assignments zₙ=i and zₘ=j. Let X be random variables (x₁, . . . x_{K},) where xᵢ=0,1 represent role membership of entities, with xᵢ indicates whether an entity has the i-th role, and Iₙ and Iₘ drawn from X be the role membership of eₙ and eₘ respectively. Then, p(a, Iₙ, Iₘ) is given by equation (15):

$$\begin{matrix}p ( a , {I}_{n} , {I}_{m} ) = \frac{p ( {z}_{n} = i , {z}_{m} = j , {I}_{n} , {I}_{m} , a )}{p ( {I}_{n} , {I}_{m} , a )} \\ = \frac{p ( {z}_{n} = i , {z}_{m} = j , {I}_{n} , {I}_{m} ) p ( {I}_{n} , {I}_{m} ) p ( {I}_{n} , {I}_{m} )}{p ( {I}_{n} , {I}_{m} ) p ( {I}_{n} , {I}_{m} )} \\ = \frac{p ( {z}_{n} = i , {z}_{m} = j ) p ( {I}_{n} , {I}_{m} )}{{\sum }_{( i , j ) ∈ ( {I}_{n} , {I}_{m} )} p ( {z}_{n} = i , {z}_{m} = j ) ( {I}_{n} , {I}_{m} )} \\ = \frac{p ( {z}_{n} = i , {z}_{m} = j )}{{\sum }_{( i , j ) ∈ ( {I}_{n} , {I}_{m} )} p ( {z}_{n} = i , {z}_{m} = j )}\end{matrix} \qquad ( 15 )$$

$$where p ( {z}_{n} = i , {z}_{m} = j ) = \frac{{C}_{a}^{A R} [ i ] [ j ]}{{\sum }_{t}^{T} {C}_{{a}_{t}}^{A R} [ i ] [ j ]}$$

$$and i , j = 1 ⋯ K$$

This formulation may enable the system to compute the most probable role assignments for entity pairs based on observed activities and established role memberships.

With continued reference to FIG. 5, the conditional probability of an activity given role assignments may be computed using the activity-role count matrix 500. The numerator C^{AR}ₐ[i][j] may represent the count of activity type a being associated with entity pairs having roles i and j. The denominator may sum over all activity types t from 1 to T to normalize the count, yielding a probability value that indicates how likely activity a occurs when entities have roles i and j assigned. This probability computation may leverage the activity-role count matrices C^{AR} accumulated during the Gibbs sampling inference process to estimate the likelihood of specific activities occurring between entities with particular role assignments.

In some embodiments, the structure discovery process may employ rule mining to extract interaction patterns among functional roles by correlating roles of entities and interactions between entities. The rule mining process may analyze the aggregated role interactions shown in FIG. 5 to identify patterns that define permissible behaviors within the system's functional structure. The correlation between roles and interactions may reveal the underlying rules that govern how different functional roles interact with one another through specific activity types.

The output of the rule mining process may comprise a set of tuples (r₁, r₂, a) with an associated probability p. Each tuple may indicate that role r₁ performs activity a with role r₂ with a probability of p. As shown in FIG. 5, the connections between Role 2, Role 1, and Role k nodes with their associated probability values may represent examples of such tuples, where the edge labels a1 and a3 may indicate specific activity types and the numerical values may indicate the probabilities of those interactions occurring. The set of tuples generated through the rule mining process may define the structural rules that characterize normal system behavior and serve as the baseline for subsequent anomaly detection operations.

Referring again to FIG. 1, a three-stage process for structural anomaly detection may be implemented to identify deviations from normal system behavior based on discovered functional roles and structural rules. The three-stage process may transform raw system logs 101 into actionable anomaly detection results through sequential processing stages that build upon one another to establish and enforce structural norms within the monitored system. At Stage 1, the processing module 102 may perform role detection of the input data, namely, logs 101. The system logs L may be represented as tuples of the form (entity, activity, entity), where each tuple captures an interaction between a first entity and a second entity through a specific activity. The role detection stage may apply the SysLDA generative process to the system logs to infer latent role assignments for entities based on their observed activities and interaction patterns. The output of Stage 1 may comprise role assignments that associate each entity with one or more functional roles based on the probabilistic analysis of entity behaviors captured in the system logs.

Stage 2 of the process may be performed by the structure discovery module 104, and may perform structure discovery with input of role assignments and activities generated during Stage 1. The structure discovery stage may aggregate role interactions to extract structural rules that define permissible behaviors within the system's functional architecture. The role assignments from the processing module 102 at Stage 1 may be combined with the observed activities to identify correlation strengths between role pairs and establish the baseline of normal structural behavior. The output of the structure discover module 104 at Stage 2 may comprise a set of structural rules that specify which role-to-role interactions are considered permissible within the system, along with associated probability values that quantify the likelihood of specific interactions occurring between entities with particular role assignments.

At stage 3, the anomaly detection module 106 may perform anomaly detection with input of new activity and structural rules established during Stage 2. The anomaly detection stage may compare observed activities against the structural rules to determine whether activities conform to or deviate from the established functional structure. New activities may be evaluated by computing the probability of the activity given the role assignments of participating entities and comparing this probability against a predetermined threshold δ to classify activities as permissible or impermissible.

During normal system operation conforming to structural rules, multiple entities including a first entity eₙ and a second entity eₘ may be associated with various functional roles. A first role may connect to a second role with a probability notation indicating a permissible interaction per the discovered structure. A role assignment may have a probability value indicating a strong association between the entity and the assigned role. Permitted activities may occur where the probability p is much greater than the threshold δ. Such interactions may conform to the structural rules established by the structure discovery module 104, where the computed probability of the activity given the role assignments exceeds the predetermined threshold and the activity is classified as permissible within the system's functional structure.

Anomalous activity may be detected as a structural violation when an entity interacts with entities having roles through an activity that deviates from expected patterns. When the probability of an activity given the role assignments is low, the interaction may be flagged as impermissible, resulting in structural anomaly detection. The conditional probability P(a|zₙ=i, zₘ=j) may indicate the probability of the activity given the role assignments. Anomalous activities may occur where the probability p is much less than the threshold δ, indicating that the observed activity deviates from the expected structural patterns and violates the established functional rules.

The determination of permissible versus impermissible activities may be based on whether the computed probability falls within or outside the predetermined threshold δ. When the probability of an observed activity given the role assignments of participating entities exceeds the threshold δ, the activity may be classified as permissible and consistent with normal system operation. When the probability falls below the threshold δ, the activity may be classified as impermissible and flagged as a structural anomaly that warrants further investigation. The threshold δ may serve as a tunable parameter that controls the sensitivity of the anomaly detection process, with lower threshold values resulting in fewer activities being flagged as anomalous and higher threshold values resulting in more stringent enforcement of structural rules.

The structural anomaly detection system 10 may enable the detection of structural anomalies that would not be identified through traditional anomaly detection methods that focus on individual entity behaviors or statistical outliers. By establishing a baseline of normal structural behavior through role detection and structure discovery, the system 10 may identify activities that violate the system's intended functional architecture even when individual behaviors appear normal in isolation. The structural approach may be particularly effective for detecting advanced persistent threats (APTs) and sophisticated attacks that attempt to blend in with normal system operations while pursuing malicious objectives that deviate from the system's intended purpose. In particular, the system can determine whether the observed activity is impermissible comprises detecting an APT that appears normal when examined in isolation but violates the discovered rules when analyzed in context of the role interactions.

As described with reference to embodiments above, anomaly detection may aim to establish some form of regularity and measure any deviations from it. The discovered structure from previous steps may serve as the regularity of a system and may define the system dynamics and expected interaction patterns between functional roles. System structure may be defined as a set of rules, with each rule defining which role interacts with which role via a certain activity. Entities performing activities that defy these rules may indicate deviation from the system structure and may appear as structural anomalies. Structural anomalies may be identified as intrusions, and an intruder may occur in two forms within the monitored system.

A first form of intruder may comprise a new entity that is created and injected by an adversary into the system. Examples of new entities injected by adversaries may include a malicious file being downloaded and added to the file system, a new user account being created and controlled by the adversary, a rogue network device being introduced into the network infrastructure, or a malicious process being spawned within the computing environment. The injected entity may attempt to perform activities within the system that deviate from the established structural rules, as the adversary-controlled entity may not conform to the functional role patterns learned from legitimate system operations.

A second form of structural anomaly may comprise an existing entity that has been compromised and hijacked by an adversary. In this form, a legitimate entity that previously performed normal functions within the system may be taken over by an adversary and used to conduct malicious activities. The compromised entity may retain its original role assignments based on historical behavior patterns, but the activities performed by the compromised entity under adversary control may deviate from the structural rules that govern permissible interactions for entities with those role assignments. The hijacked entity may attempt to access resources, communicate with other entities, or perform operations that are inconsistent with the functional structure established during the structure discovery phase.

The structural anomaly detection methodology may operate under a baseline assumption that if a majority of entities within the monitored system are not compromised and are performing normal functions, the structural patterns extracted during the role detection and structure discovery phases presumably remain intact and may serve as a valid baseline for anomaly detection. This baseline assumption may enable the system to distinguish between legitimate system behaviors and anomalous activities introduced by adversaries, as the structural rules derived from the majority of non-compromised entities may accurately represent the intended functional architecture of the system.

The baseline assumption may provide robustness against scenarios where a limited number of entities have been compromised or where adversaries have injected a small number of malicious entities into the system. When the majority of entities continue to operate normally, the aggregated role interactions and structural patterns may remain representative of legitimate system behavior, enabling the anomaly detection module to identify deviations introduced by the minority of compromised or injected entities. The structural rules extracted from the majority baseline may serve as a reference against which individual entity activities are evaluated to determine whether those activities conform to or violate the established functional structure.

Entities that perform activities defying the structural rules may indicate deviation from the system structure and may appear as structural anomalies representing intrusions. When an entity, whether newly injected or previously compromised, conducts an activity that is not permitted according to the discovered functional structure rules, the activity may be flagged as anomalous. The structural anomaly may manifest as an interaction between roles that is not supported by the mined rules, an activity type that is inconsistent with the role assignments of the participating entities, or a probability value that falls below the predetermined threshold for permissible interactions. The identification of such structural anomalies may enable security analysts to detect intrusions that would otherwise evade detection methods focused on individual entity behaviors or known attack signatures. In other words, a feature is that the system in accordance with embodiments can determine whether the observed activity is impermissible comprises detecting a novel attack that does not match a known attack signature.

SysLDA may model latent activities and entity roles with interpretable information derived from activities, which may improve explainability over black-box machine learning approaches. The interpretability of SysLDA may arise from the explicit modeling of entity-role probability distributions and activity-role mixtures, which may provide security analysts with meaningful insights into why specific activities are classified as anomalous. Unlike neural network-based approaches that may produce opaque classification decisions, the SysLDA framework may enable analysts to trace anomaly classifications back to specific role assignments, probability thresholds, and structural rule violations. The entity-role probability matrix P^{ER} may provide quantitative evidence supporting role assignments, while the activity-role count matrices C^{AR} may reveal the statistical basis for activity-role associations. This transparency may facilitate more effective incident response by enabling analysts to understand the functional context of detected anomalies and prioritize responses based on the severity of structural violations.

The methodology may decouple pattern recognition from anomaly detection, which may avoid biasing role detection to only find anomalies. The decoupling may be achieved through the sequential three-stage process where role detection and structure discovery operate independently of the anomaly detection phase. During the role detection phase, the SysLDA generative process may learn entity-role distributions based solely on observed activity patterns without any prior knowledge of which activities may be anomalous. The structure discovery phase may extract structural rules from the learned role distributions without incorporating anomaly labels or attack signatures. This separation may ensure that the baseline of normal structural behavior is established from the full spectrum of observed activities rather than being skewed toward patterns that distinguish anomalies from normal behavior. The decoupled approach may enable the system to detect novel attack patterns that were not present in training data, as the structural rules may capture the intended functional architecture of the system rather than specific characteristics of known attacks.

The structural anomaly detection approach may be suitable for complex modern environments such as cloud systems and Internet of Things (IoT) deployments where behaviors may be difficult to characterize. Cloud environments may present challenges for traditional anomaly detection due to dynamic resource allocation, multi-tenant architectures, and elastic scaling that may cause legitimate behavioral variations. IoT deployments may involve heterogeneous devices with diverse communication patterns and limited computational resources that may preclude deployment of complex detection algorithms on individual devices. The structural anomaly detection methodology may address these challenges by operating at a higher level of abstraction that focuses on functional roles and structural interactions rather than specific device behaviors or network signatures. The generic nature of the SysLDA approach may enable deployment across diverse system types without requiring specialized domain knowledge or extensive customization for each environment. The methodology may adapt to evolving system configurations by continuously updating role assignments and structural rules based on observed activities, enabling detection of anomalies in dynamic environments where the baseline of normal behavior may shift over time.

A number of implementations have been described. Nevertheless, it will be understood that various modifications may be made without departing from the spirit and scope of the disclosure. Accordingly, other implementations are within the scope of the following claims.

What is claimed is:

1. A method for structural anomaly detection, comprising:
receiving system data comprising interaction records, each interaction record including a first entity, an activity, and a second entity;
applying a generative process to compute latent variables corresponding to the first entity and the second entity, wherein the latent variables represent functional roles;
computing a probability matrix based on the latent variables to quantify a likelihood of each entity performing each of the functional roles;
discovering structural rules by aggregating interactions between the functional roles;
comparing an observed activity from an interaction record of the interaction records against the structural rules to compute a probability of the observed activity; and
determining whether the observed activity is permissible or impermissible based on whether the computed probability falls within or outside a threshold.

2. The method of claim 1, further comprising grouping the interaction records by entity pairs, wherein each entity pair comprises the first entity and the second entity, and wherein grouping by entity pairs forms an activity set for each entity pair to enable the generative process to model activities between specific pairs of entities.

3. The method of claim 2, wherein applying the generative process comprises:
computing a marginal distribution of the activity set for each entity pair by integrating over an entity-role mixture and an activity-role mixture, wherein the entity-role mixture is parameterized by a first hyperparameter that governs how the first entity and the second entity are assigned to the functional roles, and wherein the activity-role mixture is parameterized by a second hyperparameter that governs relationships between the functional roles and the activities in the activity set.

4. The method of claim 1, wherein the generative process includes a System Latent Dirichlet Allocation (SysLDA) generative process.

5. The method of claim 1, wherein computing the probability matrix comprises performing posterior inference using Gibbs sampling.

6. The method of claim 1, further comprising applying a role-membership threshold to the probability matrix to determine assigned roles for entities.

7. The method of claim 1, wherein discovering the structural rules comprises generating a set of structural rules, each structural rule comprising a tuple indicating that a first functional role interacts with a second functional role via the activity with a probability.

8. The method of claim 1, further comprising generating an alert when the observed activity is determined to be impermissible, wherein the alert includes violated structural rules, role context information, and threat priority assessment.

9. The method of claim 1, wherein the latent variables provide interpretable role assignments that enable tracing anomaly classifications to specific role assignments and rule violations.

10. The method of claim 1, wherein applying the generative process to compute the latent variables is decoupled from determining whether the observed activity is permissible or impermissible, such that role detection is not biased toward finding anomalies.

11. The method of claim 1, wherein the method profiles the system holistically by modeling the roles and the role interactions rather than analyzing individual entities in isolation.

12. The method of claim 1, wherein determining whether the observed activity is impermissible comprises detecting malicious behavior that mimics normal usage patterns but violates the discovered rules.

13. A method for structural anomaly detection, the method comprising:
computing latent variables corresponding to a first entity and a second entity in a system, wherein the first entity and the second entity form an entity pair that performs a functional role;
for the entity pair, computing a marginal distribution of a set of activities between the first entity and the second entity, and computing a posterior distribution of the latent variables;
computing a joint distribution of an entity-role mixture for each activity in the set of activities, wherein the entity-role mixture is parameterized by a first hyperparameter, and computing an activity-role mixture parameterized by a second hyperparameter;
determining a probability of the first entity and the second entity performing each of a plurality of functional roles; and
determining whether an activity of the first entity and the second entity is permissible based on the probability falling within a predetermined threshold, or impermissible based on the probability falling outside of the predetermined threshold.

14. The method of claim 13, wherein applying the generative process comprises computing a joint distribution of an entity-role mixture parameterized by an alpha hyperparameter and an activity-role mixture parameterized by a beta hyperparameter.

15. The method of claim 13, wherein the generative process includes a System Latent Dirichlet Allocation (SysLDA) generative process.

16. The method of claim 13, wherein computing the probability matrix comprises performing posterior inference using Gibbs sampling.

17. The method of claim 13, wherein determining whether the observed activity is impermissible comprises detecting at least one of: a novel attack that does not match a known attack signature, or an advanced persistent threat (APT) that appears normal when examined in isolation but violates the discovered rules when analyzed in context of the role interactions.

18. The method of claim 13, wherein the latent variables provide interpretable role assignments that enable tracing anomaly classifications to specific role assignments and rule violations.

19. The method of claim 13, wherein the generative process further comprises:
choosing a number of activities from a Poisson distribution;
choosing an entity-role probability distribution from a Dirichlet distribution parameterized by a first hyperparameter that governs how entities are assigned to the functional roles;
for each activity, choosing the role assignments for entities from a categorical distribution; and
generating the activities from a multinomial distribution based on the role assignments and an activity-role mixture parameterized by a second hyperparameter that governs relationships between the functional roles and the activities.

20. A structural anomaly detection system, comprising:
a processing module configured to receive system data comprising interaction records, each interaction record including a first entity, an activity, and a second entity, wherein the processing module applies a generative process to compute latent variables corresponding to the first entity and the second entity, wherein the latent variables represent functional roles, and wherein the generative process uses a first hyperparameter that governs how entities are assigned to the functional roles and a second hyperparameter that governs relationships between the functional roles and the activities;
a structure discovery module configured to receive an entity-role probability matrix from the processing module and to discover structural rules by aggregating interactions between the functional roles;
an anomaly detection module configured to compare an observed activity against the structural rules to compute a probability of the observed activity and to determine whether the observed activity is permissible or impermissible based on whether the computed probability falls within or outside a threshold; and
an anomaly classification module configured to classify detected anomalies and to receive input from continuous learning capabilities to improve detection accuracy.
